(19) United States
(12) Patent Application Publication
(10) Pub. No.: US 2021/0200051 A1
(43) Pub. Date: Jul. 1, 2021

(54) ULTRATHIN ELECTROCHROMIC DEVICE FOR HIGH OPTICAL MODULATION

(71) Applicant: NITTO DENKO CORPORATION, Osaka (JP)

(72) Inventor: Liping Ma, San Diego, CA (US)

(21) Appl. No.: 17/269,498

(22) PCT Filed: Aug. 22, 2019
(86) PCT No.: PCT/US2019/047776

§ 371 Date: Feb. 18, 2021

Related U.S. Application Data
(60) Provisional application No. 62/722,069, filed on Aug. 23, 2018.
(60) Provisional application No. 62/821,910, filed on Mar. 21, 2019.

(51) Int. Cl. G02F 1/1524; G02F 1/155; G02F 1/1516

(52) U.S. Cl. CPC G02F 1/1524; G02F 2001/1536; G02F 1/15165; G02F 1/155

(57) ABSTRACT

The present disclosure relates to electrochromic devices including an insulating layer and at least one electrochromic material having one or more optical properties that may be changed upon application of an electric potential. The device may include a conductive nanoparticle layer and/or a buffer layer. Upon provision of an electric potential above a threshold, electrons and holes may be injected into the electrochromic material and blocked by the insulating layer, resulting in an accumulation of the electrons and holes in their respective electrochromic material resulting in a change to the one or more optical properties of the electrochromic material. An opposite electric potential may be provided to reverse the change in the one or more optical properties.

### CROSS REFERENCE TO RELATED APPLICATIONS

This application claims the benefit of U.S. Provisional Application No. 62/722,069, filed Aug. 23, 2018, and 62/821,910, filed Mar. 21, 2019, both of which are incorporated by reference in their entireties.

### FIELD

The present disclosure relates to electrochromic elements and devices comprising an insulating layer and electrochromic materials having one or more optical properties that may be changed from a first optical property state to a second optical property state upon application of an electric potential.

### BACKGROUND

Electrochromic coatings or materials may be used for several different purposes. One such purpose includes controlling the amount of light and heat passing through a window based on a user-controlled electrical potential that is applied to an electrochromic coating. An electrochromic coating or material can reduce the amount of energy necessary to heat or cool a room and can provide privacy. For example, a clear state of the electrochromic coating or material, having an optical transmission of about 60-80%, can be switched to a darkened state, having an optical transmission of between 0.1-10%, where the energy flow into the room is limited and additional privacy is provided. Due to large amounts of glass found in various types of windows, such as skylights, aircraft windows, automobile windows, and residential and commercial building windows, there may be energy savings provided by the use of an electrochromic coating or material on glass.

Despite the potential benefits that an electrochromic coating or device may provide, various issues may make current electrochromic devices undesirable for some applications. For example, in electrochromic devices utilizing an electrolyte, low ion mobility of the electrolyte may cause reductions in switching speeds and temperature-dependence issues. Ion intercalation may also occur in the electrochromic layer of an electrolyte-based device which causes the device volume to expand, and resultant mechanical stresses may limit the ability to operate between on and off cycles of the device. In such devices, there is a trade-off between high-speed switching and uniform switching because high ion mobility gives a very low internal device resistance for a larger area device, and this may lead to non-uniformity in application of an electric field across the whole device area. A further limitation of some electrochromic devices is the need for continuous application of electrical power in order to retain changes to the optical properties of the electrochromic material. Thus, there remains a need for further contributions in this area of technology.

### SUMMARY

Disclosed herein are electrochromic devices, which include an electrochromic element having one or more optical properties that can change from a first state to a second state upon application of an electric potential. The present disclosure also describes electrochromic devices having a blocking layer that exhibits insulative properties intended for retaining changes to the optical properties of the electrochromic material following application of the electric potential. Furthermore, the present disclosure relates to electrochromic devices exhibiting localized surface plasmon resonance properties intended to increase the differentiation of the opacity between the on and off state.

Some embodiments include an electrochromic element comprising: a first electrode layer, wherein the first electrode layer comprises a transparent conductive material; a first electrochromic layer in electrical communication with the first electrode layer, wherein the first electrochromic layer comprises a p-type electrochromic material; an insulating layer in electrical communication with the first electrochromic layer; a second electrochromic layer in electrical communication with the insulating layer, wherein the second electrochromic layer comprises an n-type electrochromic material; and a second electrode layer in electrical communication with the second electrochromic layer, wherein the second electrode layer comprises a transparent conductive material.

Some embodiments include an electrochromic device comprising: an electrochemical element described herein, wherein the element further comprises a power source, wherein the power source is in electrical communication with the first electrode layer and the second electrode layer to provide an electric potential to the device.

In addition, the present disclosure provides methods for the preparation of the electrochromic elements and devices described herein.

### BRIEF DESCRIPTION OF THE DRAWINGS

FIG. 1 is a schematic illustration of one embodiment of an electrochromic element.

FIG. 2 is a schematic illustration of one embodiment of an electrochromic device.

FIG. 3 is an illustration showing the electron drift through the solid state electrolytic layer (Ta₂O₅) and accumulation of electrons and holes at the nickel oxide electrolytic interface of a conventional electrochromic device.

FIG. 4 is an illustration showing the electron blockage by a metal oxide insulating layer (Al₂O₃) allowing for the accumulation of electrons in the n-type electrochromic layer and holes in the p-type electrochromic layer in an electrochromic device with an insulating layer with a high band gap and a high conductance minimum band relative to the Fermi level.

FIG. 5 is an illustration showing the electron blockage by a metal nitride insulating layer (AlN) allowing for the accumulation of electrons in the n-type electrochromic layer and holes in the p-type electrochromic layer in an electrochromic device with an insulating layer with a high band gap and a low conductance minimum band relative to the Fermi level.

FIG. 6 is a graphic illustration showing the total transmission (T %) as a function of wavelength (nm) of the device of Example CE-1 in an ON state and OFF state.

FIG. 7 is a graphic illustration showing the total transmission (T %) as a function of wavelength (nm) of a comparative embodiment of the device of example EC-2 in an ON state and OFF state.

FIG. 8 is a graphic illustration showing the total transmission (1%) as a function of wavelength (nm) of an alternative embodiment of the device of example EC-1 in an ON state and OFF state.

FIG. 9 is a graphic illustration showing the total transmission (T %) as a function of wavelength (nm) of an alternative embodiment of the device of example EC-3 in an ON state and OFF state.

FIG. 10 is a graphic illustration showing the total transmission (T %) as a function of wavelength (nm) of an alternative embodiment of the device of example EC-4 in an ON state and OFF state.

FIG. 11 is a graphic illustration showing the total transmission (T %) as a function of wavelength (nm) of an alternative embodiment of the device of example EC-11 in an ON state and OFF state.

FIG. 12 is a graphic illustration showing a comparison of the On-state transmission (T %) as a function of wavelength (nm) of examples CE-1, EC-1 and EC-3.

FIG. 13 is a graphic illustration showing a comparison of the On-state transmission (T %) as a function of wavelength (nm) of examples CE-2, CE-3, CE-4, CE-5, EC-4, EC-5 and EC-6.

FIG. 14 is a graphic illustration showing the baseline total transmission (T %) as a function of wavelength (nm) of example EC-9 in an ON state and OFF state.

FIG. 15 is a graphic illustration showing the total transmission (T %) as a function of wavelength (nm) of example EC-9 after baking the device at 70° C. for 127 hours in an ON state and OFF state.

FIG. 16 is a schematic of the device used for cycle durability testing.

FIG. 17 is a graphic illustration showing the cycle durability of device of EC-1.

FIG. 18 is a graphic illustration showing the coloration efficiency of device EC-1.

### DETAILED DESCRIPTION

As used herein, the term “transparent” includes a property in which the corresponding material transmits or allows light to pass through the material. In one aspect, the transmittance of light through the transparent material may be about 50-100%, such as at least about 50%, at least about 60%, at least about 70%, at least about 80%, at least about 90%, at least about 95%, at least about 99%, about 50-60%, about 60-70%, about 70-80%, about 80-90%, about 90-95%, or about 95%-99%.

The term “light” as used herein includes light in a wavelength region targeted by the electrochromic element or device. For example, when the electrochromic material or device is used as a filter of an image pickup apparatus for a visible light region, light in the visible light region is targeted, and when the electrochromic material is used as a filter of an image pickup apparatus for an infrared region, light in the infrared region is targeted.

The term “darkness efficiency” as used herein includes the efficiency of the electrochromic element's/device's optical modulation ratio per unit of the electrochromic layer thickness represented by the following formula:

$$Darkness efficiency = \frac{T \% ( OFF \text{-} state ) / T \% ( ON \text{-} state )}{EC \text{-} layer thickness ( nm )}$$

wherein T % is the transmittance percentage in the off-state (clear state) and the on-state (dark state) and the EC layer thickness is the thickness of the electrochromic stack in nm.

The term “band gap” (energy gap) as used herein has its ordinary meaning in the art and a person of ordinary skill in the art would recognize the term as including the energy required, measured in electron volts (eV), to promote a bound valance electron to become a conductive electron free to move within a solid layer. The conductive electron can serve as a charge carrier to conduct electrical current.

The present disclosure generally relates to electrochromic elements and devices. The electrochromic devices herein include at least one electrochromic element having one or more optical properties, such as transparency, absorption, or transmittance, that may be changed from a first state to a second state upon application of an electric potential. More particularly, but not exclusively, the present disclosure relates to electrochromic elements and devices comprising ultrathin layers, exhibiting improved on- and off-state transmittance differentiation properties following application of the electric potential.

Generally, an electrochromic element comprises a first electrode and a second electrode. One or more blocking layers and one or more electrochromic layers may be disposed between the first electrode and the second electrode. In some cases, a conductive nanostructured metal layer may be disposed on an electrochromic layer. In some embodiments, a buffer layer may be present. Additional layers, such as a protection layer, may also be present in some embodiments of the electrochromic elements and devices disclosed herein.

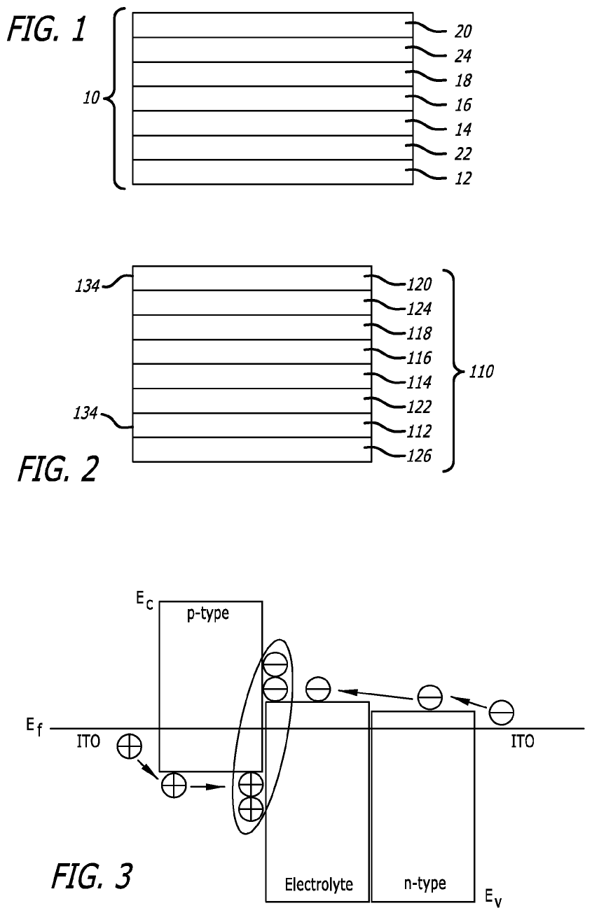

There are many potential configurations for the electrochromic element. One potentially useful configuration is depicted in FIG. 1. An electrochromic element, such as electrochromic element 10 in FIG. 1, comprises (e.g., in the order depicted, from bottom to top): a first electrode layer 12, which is a conductive layer; a first electrochromic layer 14 comprising an electrochromic material; an insulating layer 16, which may also be termed a blocking layer, a barrier layer or a tunneling layer, and which comprises an electrically insulative material; a second electrochromic layer 18, comprising an electrochromic material; and a second electrode layer 20, which is a conductive material. In some embodiments, the layers of the electrochromic element are in electrical and optical communication with one another. In some embodiments, the electrochromic layers of the electrochromic element may change from a first state (clear or transparent) to a second state (colored or darkened). In some embodiments, the electrochromic element can further comprise a buffer layer 22 disposed between and in optical and electrical communication with the first electrode layer 12, and the first electrochromic layer 14. In some embodiments, the electrical element can further comprise a tunneling nanoparticle layer 24 disposed between and in optical and electrical communication with the second electrode layer 20 and the second electrochromic layer 18. In some embodiments, the presence of the buffer layer or the tunneling nanoparticle layer in the electrochromic element is desired when the first electrochromic layer does not comprise a nanostructured morphology, as described below.

In some embodiments, the recited layers of the element are disposed in the recited order from bottom to top. In some embodiments, the recited layers of the electrochromic element are contacting one another in that order from bottom to top. Alternative arrangements of the layers of the electrochromic element are also contemplated.

Generally, an electrochromic device comprises the electrochromic element described above, or elsewhere herein, and a power source in electrical communication with the first electrode and the second electrode, to provide an electric potential to the electrochromic device.

There are many potential configurations for the electrochromic device. One potentially useful configuration is depicted in FIG. 2. In FIG. 2, an electrochromic device, such as device 110, comprises (e.g., in the order depicted): a first electrode layer 112, which is a conductive layer; a first electrochromic layer 114, comprising an electrochromic material; an insulating layer 116, which may also be termed a blocking layer, a barrier layer or a tunneling layer, and which comprises an electrically insulative material; a second electrochromic layer 118, comprising an electrochromic material; a second electrode layer 120, which is a conductive material; and a power source, such as power source 134, which is in electrical communication with the first electrode and the second electrode. In some embodiments, the layers of the electrochromic device are in electrical and optical communication with one another. In some embodiments, the electrochromic layers of the electrochromic device may change from a first state (clear or transparent) to a second state (colored or darkened). In some embodiments, the electrochromic device can further comprise a buffer layer 122 disposed between and in optical and electrical communication with the first electrode layer 112 and the first electrochromic layer 114. In some embodiments, the electrical element can further comprise a tunneling nanoparticle layer 124 disposed between and in optical and electrical communication with the second electrode layer 120 and the second electrochromic layer 118. In some embodiments, the electrochromic device can further comprise a protective layer 126. The presence of the buffer layer or the tunneling nanoparticle layer in the electrochromic device is desired in embodiments wherein the first electrochromic layer does not comprise a nanostructured morphology, as described below.

In some embodiments, the layers of the device are disposed in the recited order from bottom to top. In some embodiments, the layers of the electrochromic device are contacting one another in that order from bottom to top. In some embodiments, the layers of the device are contacting one another in that order from top to bottom. Alternative arrangements of the layers of the electrochromic device are also contemplated.

The electrochromic elements and devices described herein comprise an electrode on, or adjacent to, the top and the bottom of the various electrochromic element or device layers. In some embodiments, the electrodes (“electrodes,” “the electrodes,” or a similar phrase is used as shorthand herein for “first electrode and/or second electrode”) may be formed on a bonding layer and/or a substrate. The electrodes may comprise a transparent material, which may also be conductive. When one or more of the electrodes are transparent, light and energy can be efficiently transmitted to the inner layers of the element or device and may interact with the electrochromic materials and other layers within the element or device.

In some embodiments, the electrochromic elements comprise a first electrode layer and a second electrode layer. The first electrode and the second electrode may be defined in their entirety by the electrode(s) found in these layers, or it is possible that the electrodes of these layers only partially define these layers. In some embodiments, the electrodes of these layers may be formed on a bonding layer and/or substrate. In some embodiments, the remainder of the electrode layers, wherein the electrodes only partially define these layers, may be formed of a transparent material. In some examples, when one or more of the electrodes and layers are transparent, light can be efficiently taken in from the outside of layers to interact with the electrochromic material of the electrochromic element and enables optical modulation of the electrochromic material on emitted light.

In some examples, the electrodes may comprise a transparent conductive oxide, dispersed carbon nanotubes on a transparent substrate, partly arranging metal wires on a transparent substrate, or combinations thereof. In some embodiments, the electrodes may be formed from a transparent conductive oxide material having good transmissivity and conductivity, such as tin-doped indium oxide (also called indium tin oxide, or ITO), zinc oxide, gallium-doped zinc oxide (GZO), indium zinc oxide (IZO), aluminum-doped zinc oxide (AZO), tin oxide, antimony-doped tin oxide (ATO), fluorine-doped tin oxide (FTO), niobium-doped titanium oxide (TNO), a conductive polymer material, or a material containing Ag, Ag nanoparticles, carbon nanotubes or graphene. Of the transparent conductive oxide materials identified above, FTO may be selected for heat resistance, reduction resistance, and conductivity and ITO may be selected for conductivity and transparency. In the event a porous electrode is formed and calcined, then the transparent conductive oxide, if used, preferably has high heat resistance. One or more of the electrodes may contain one of these materials, or one or more of the electrodes may have a multi-layer structure containing a plurality of these materials. In an alternative form, one or more of the electrodes may be formed from a reflective material such as a Group 10 of 11 metal, non-limiting examples of which include Au, Ag, and/or Pt. Forms in which the reflective material is a Group 13 metal, such as aluminum (Al) are also possible.

In some embodiments, the first electrode is indium tin oxide. In some examples, the thickness of the first electrode (e.g., an ITO electrode) is about 10 nm to about 300 nm, about 10-12 nm, about 12-14 nm, about 14-16 nm, about 16-18 nm, about 18-20 nm, about 20-22 nm, about 22-24 nm, about 24-26 nm, about 26-28 nm, about 28-30 nm, about 30-35 nm, about 35-40 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 75-85 nm, about 15-25 nm, about 1-50 nm, about 50-100 nm, about 100-150 nm, about 80 nm, about 20 nm, about 185 nm, or about any thickness bounded by any of the above ranges.

In some embodiments, the second electrode is indium tin oxide. In some examples, the thickness of the second electrode (e.g., an ITO electrode) is about 10 nm to about 150 nm, about 10-12 nm, about 12-14 nm, about 14-16 nm, about 16-18 nm, about 18-20 nm, about 20-22 nm, about 22-24 nm, about 24-26 nm, about 26-28 nm, about 28-30 nm, about 30-35 nm, about 35-40 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 15-25 nm, about 1-50 nm, about 50-100 nm, about 100-150 nm, about 80 nm, or about 20 nm.

The second electrode layer may comprise a nanostructured surface morphology complementary to the corresponding nanostructured surface morphology of the buffer layer (or first electrochromic layer) projecting through the ultrathin layers of the present disclosure, as discussed in greater detail below.

In some embodiments, the electrochromic element further comprises a buffer layer, wherein the buffer layer can be disposed between, and in electrical and optical communication with, the first electrode layer and the first electrochromic layer. In some embodiments, the buffer layer can have a surface comprising a nanostructured or rough morphology. In some embodiments, the buffer layer can comprise a surface imprinted with the same or similar morphology as described with reference to the second electrode layer's nanostructured or rough surface morphology. In some embodiments, the buffer layer comprises NiO. In some embodiments, the buffer layer comprises an organic material. In some embodiments, the organic material can comprise a non-polymeric organic compound. In still other embodiments, the non-polymeric organic compound may comprise an optionally substituted aromatic ring. In some embodiments, where the buffer layer may be present, it may comprise a bisphenyl pyridine compound. A suitable bisphenyl pyridine compound can be a 3,5-diphenylpyridine. In one form, the bisphenyl pyridine compound may include the bisphenyl pyridine compounds described in U.S. Pat. No. 9,051,284, which is incorporated by reference in its entirety for its description of organic compounds, e.g., bisphenyl pyridine compounds. In one particular, but non-limiting form, the bisphenyl pyridine is compound-1 (or BC-1):

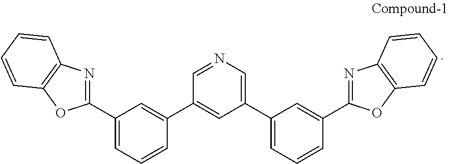 [SMILES: c1cc(-c2cncc(-c3cccc(-c4nc5ccccc5o4)c3)c2)cc(-c2nc3ccccc3o2)c1]

In some forms, the buffer layer (e.g., containing BC-1 or NiO) can have a thickness of about 0.1 nm-50 nm, about 0.1-0.2 nm, about 0.2-0.3 nm, about 0.3-0.4 nm, about 0.4-0.5 nm, about 0.5-0.6 nm, about 0.6-0.7 nm, about 0.7-0.8 nm, about 0.8-0.9 nm, about 0.9-1 nm, about 1-1.1 nm, about 1.1-1.2 nm, about 1.2-1.3 nm, about 1.3-1.4 nm, about 1.5-1.6 nm, about 1.6-1.7 nm, about 1.7-1.8 nm, about 1.8-1.9 nm, about 1.9-2 nm, about 0.1-2 nm, about 2-3 nm, about 3-4 nm, about 4-5 nm, about 5-6 nm, about 6-7 nm, about 7-8 nm, about 8-9 nm, about 9-10 nm, about 10-15 nm, about 15-20 nm, about 20-25 nm, about 25-30 nm, about 30-35 nm, about 35-40 nm, about 40-45 nm, about 45-50 nm, about 0.1-10 nm, about 10-20 nm, about 20-30, nm, about 30-40 nm, about 40-50 nm, about 0.1-25 nm, about 25-50 nm, about 1 nm, about 2 nm, about 3 nm, about 4 nm, about 10 nm, about 20 nm, about 30 nm, or any thickness in a range bounded by any of these values.

In some embodiments, as discussed in detail below regarding the first electrochromic layer, the buffer layer comprises the first electrochromic layer.

Some embodiments include electrochromic elements or electrochromic devices comprising one or more electrochromic layers. The electrochromic layers of the elements and devices described herein can comprise electrochromic materials containing charge sensitive materials. In some embodiments, the electrochromic layers of the electrochromic element or device comprise one or more optical properties that may change from a first state (clear or transparent) to a second state (colored or darkened) upon the application of an electric potential. In some embodiments, the electrochromic material of the first electrochromic layer can include p-type electrochromic materials. As used herein, the term “p-type electrochromic material” refers to a material in which its Fermi energy level (E_{f}) is closer to the valence band energy level (Eᵥ) than its conductance band energy level (E_{c}). In some embodiments, the electrochromic material of the second electrochromic layer can include n-type electrochromic materials. As used herein, the term “n-type electrochromic material” means the refers to a material in which its Fermi energy level (E_{f}) is closer to the conductance band energy level (E_{c}) than its valance band energy level (Eᵥ).

Table 1 illustrates some electrochromic materials' E_{c}, Eᵥ, and E_{f}. This table is only for illustrative purposes and in no way is intended to limit which electrochromic materials that can be used in the current element.

TABLE 1

| | MoO₃ | V₂O₅ | WO₃ | Ta₂O₅ | NiO |
|---|---|---|---|---|---|
| E_{c} (eV) | −6.7 | −6.7 | −6.5 | −4.03 | −2.1 |
| Eᵥ (eV) | −9.7 | −9.5 | −9.8 | −7.93 | −5.3 |
| E_{f} (eV) | −6.9 | −7.0 | −6.7 | −4.45 | −4.7 |
| Material Type | n-type | n-type | n-type | n-type | p-type |

In some embodiments, the first electrochromic layer may comprise p-type electrochromic materials, which may allow the holes to be injected from the transparent conductive material of the first electrode layer (anode) into the p-type electrochromic material. The injection of holes into the p-type electrochromic material significantly enhances the oxidation of the p-type electrochromic material causing a transformation from a first state (transparent) to a second state (darkened). In some embodiments, the p-type electrochromic materials can comprise anodic materials. The term “anodic electrochromic material” as used herein means a material that undergoes changes in optical properties by an oxidation reaction thereof in which electrons are removed from the material. In some embodiments, the first electrochromic layer can undergo a crystallization of the p-type electrochromic material under annealing conditions of at least 200° C. for at least 3 minutes. In some examples, when the p-type electrochromic material crystalizes it forms a nanostructure or rough surface morphology. In cases where the p-type electrochromic material forms a nanostructured or rough surface morphology, the first electrochromic layer can perform a dual function and operate as both the electrochromic layer and as the buffer layer. When the first electrochromic layer operates in this dual capacity, the nanostructured or rough surface morphology can be transferred through the ultrathin layers of the element and imparted onto the surface of the second electrode layer.

Non-limiting examples of anodic electrochromic materials, e.g., for use in the first electrochromic layer, include nickel oxide (NiO), iridium(IV) oxide (IrO₂), chromium oxide (Cr₂O₅), manganese dioxide (MnO₂), iron oxide (FeO₂), and cobalt(II) peroxide (CoO₂). In some embodiments, the first electrochromic layer comprises nickel oxide.

The first electrochromic layer (e.g., a layer comprising NiO or another metal oxide compound in the paragraph above) may have any suitable thickness, such as about 40-500 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 300-350 nm, about 350-400 nm, about 400-450 nm, about 450-500 nm, about 80-100 nm, about 100-125 nm, about 125-150 nm, about 0.1-50 nm, about 50-100 nm, about 100-150 nm, about 0.1-60 nm, about 60-120 nm, about 120-180 nm, about 0.1-100 nm, about 100-300 nm, about 200-400 nm, about 300-500 nm, about 80 nm, about 100 nm, about 125 nm, or about 150 nm. It is believed that the ultrathin layers of the elements and devices described herein are sufficiently thin to allow the transfer of the nanostructured or rough surface morphology therethrough to affect the resultant surface morphology upon the second electrode layer, imparting a template of the nanostructured or rough surface morphology thereon.

The first electrochromic layer comprising the electrochromic material may be fixed to the first electrode layer. In some embodiments, the first electrochromic layer can be fixed to the buffer layer. The different options for fixing the first electrochromic layer are possible because in this electrochromic layer, at the time of the adjustment of charge imbalance, charge exchange between the electrodes needs only to occur by electron or hole movement through the layers and not by physical movement of the layers themselves.

In some embodiments, the electrochromic element comprises a second electrochromic layer. In some embodiments, the second electrochromic material can include n-type electrochromic materials as discussed above. N-type electrochromic materials allow electrons to be injected from the transparent conductive material of the second electrode layer (cathode). The injection of electrons into the n-type electrochromic material enhances the reduction of the n-type electrochromic material resulting in transformation of the material from a first optical state (transparent) to a second optical state (dark). In some embodiments, the n-type electrochromic materials can comprise cathodic materials. The term “cathodic electrochromic material” as used herein means a material that undergoes changes in optical properties by a reduction reaction thereof in which electrons are given to the material.

Non-limiting examples of cathodic electrochromic materials include tungsten oxide (WO₃), titanium dioxide (TiO₂), niobium oxide (Nb₂O₅), molybdenum (VI) oxide (MoO₃), tantalum(V) oxide (Ta₂O₅), and vanadium pentoxide (V₂O₅). In some embodiments, the second electrochromic layer comprises tungsten oxide.

The second electrochromic layer (e.g., comprising WO₃ or another metal oxide compound in the paragraph above) may have any suitable thickness, such as about 100-800 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 300-310 nm, about 310-320 nm, about 320-330 nm, about 330-340 nm, about 340-350 nm, about 350-360 nm, about 360-370 nm, about 370-380 nm, about 380-390 nm, about 390-400 nm, about 400-410 nm, about 410-420 nm, about 420-430 nm, about 430-440 nm, about 440-450 nm, about 450-460 nm, about 460-470 nm, about 470-480 nm, about 480-490 nm, about 490-500 nm, about 500-550 nm, about 550-600 nm, about 600-650 nm, about 650-700 nm, about 700-750 nm, about 750-800 nm, about 100-300 nm, about 200-400 nm, about 300-500 nm, about 500-700 nm, about 600-800 nm, about 150-250 nm, about 250-350 nm, about 350-450 nm, about 100 nm, about 150 nm, about 200 nm, about 400 nm, or any thickness in a range bounded by any of these values, although other variations are contemplated.

In some embodiments, the second electrochromic layer comprising the electrochromic material may be fixed to the second electrode layer. In some embodiments, where a tunneling layer exists, the second electrochromic layer can be fixed to the tunneling layer. The different options for fixing the second electrochromic layer are possible because in this layer, at the time of the adjustment of charge imbalance, charge exchange between the electrodes needs only to occur by electron or hole movement through the layers and not by physical movement of the layers themselves. Non-limiting methods of fixing the second electrochromic layer involve, for example, bonding the electrochromic material to the insulating layer through a functional group in a molecule of the electrochromic material, causing the insulating material to retain the electrochromic material in a comprehensive manner (e.g., in a film state) through the utilization of a force, such as an electrostatic interaction, or causing the electrochromic material to physically adsorb to the insulative material of the insulating layer. A method involving chemically bonding a low-molecular weight organic compound serving as the electrochromic material to a porous insulative material through a functional group thereof, or a method involving forming a high-molecular weight compound serving as the electrochromic material on the insulative material may be used when a quick reaction of the electrochromic material is desired. The former method may include fixing the low-molecular weight organic compound serving as the electrochromic material onto a fine particle oxide electrode, such as aluminum oxide, titanium oxide, zinc oxide, or tin oxide, through a functional group, such as an acid group (e.g., a phosphoric acid group or a carboxylic acid group). The latter method is, for example, a method involving polymerizing and forming a viologen polymer on an insulative and/or tunneling dielectric material and may include electrolytic polymerization. Similar methods are contemplated for fixing the first electrochromic layer to the first electrode (or the buffer layer), and to the insulating layer.

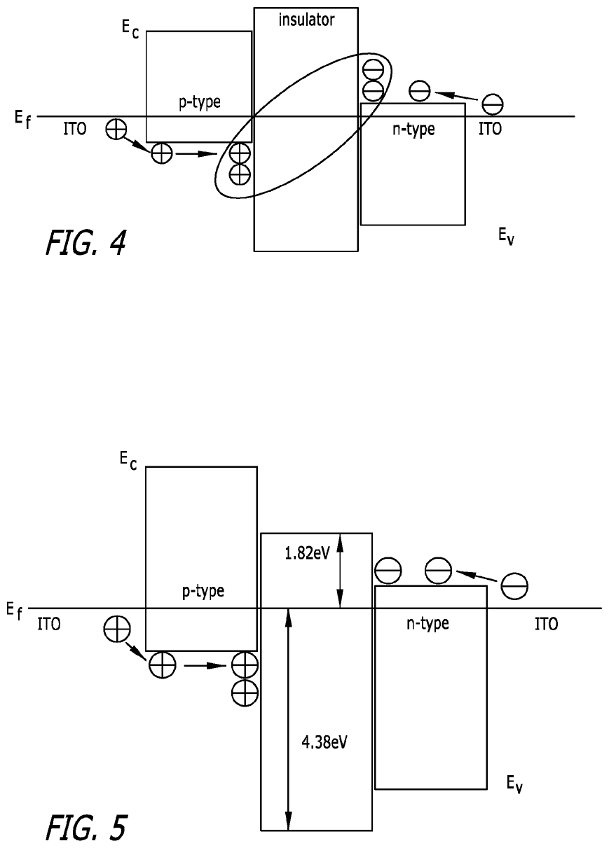

In some embodiments, the electrochromic element comprises an insulating layer. In some embodiments, the insulating layer comprises an electrically insulating material characterized by at least one of a band gap of at least 5 eV, e.g., 8.7 eV (Al₂O₃), 5.6 eV (Y₂O₃), 5.8 eV (HfO₂) and/or 5.8 eV (ZrO₂), a conductance band minimum of at least 2 eV relative to the material's Fermi level, e.g., 8.7 eV (Al₂O₃), 2.8 eV (Y₂O₃), 2.5 eV (HfO₂), and/or 2.36 eV (ZrO₂), or a relative dielectric constant of at least 5 e.g., 9 (Al₂O₃), 15 (Y₂O₃), 25 (HfO₂), and/or (ZrO₂). In the illustrated form (FIGS. 1 and 2), the electrochromic material of the first electrochromic layer is isolated from the electrochromic material of the second electrochromic layer by the insulating layer. In some embodiments, the insulating layer blocks electronic charges (e.g., electrons and holes) from moving through the device from one electrode to the other, while retaining the injected electrons from the cathode within the electrochromic material of the second electrochromic layer, and retaining the injected holes from the anode within the electrochromic material of the first electrochromic layer, for the coloration or darkening of the electrochromic layers. FIG. 3 illustrates the electron drift of the insulating material (Ta₂O₅) with a very low conductance band, relative to the Fermi energy level, thus allowing electrons to penetrate the insulating material. FIG. 4 illustrates the electron blocking of the insulating material (Al₂O₃) with a high conductance band, relative to the Fermi energy level. FIG. 5 illustrates electron blocking of the insulating material (AlN) with a low conductance band, relative to the Fermi energy level. In some embodiments, the insulating layer can reduce or prevent charge leakage between the first and second electrochromic layers. In some embodiments, the insulating layer can increase coloration efficiency. Further, the first electrode layer can also be electrically isolated or separated from the second electrochromic material layer by the insulating layer, which includes an electrically insulative material. The term “electrically insulative” refers to the reduced transmissivity of the layer to electrons and/or holes. In one form, the electrical isolation or separation between these layers may result from increased resistivity within the insulating layer. In addition, it should be appreciated that first electrode can be in electrical communication with the first electrochromic layer, which can be in electrical communication with the insulating layer, which can be in electrical communication with the second electrochromic layer, which can be in electrical communication with the second electrode layer. As indicated above, the insulating layer may include one or more electrically insulative materials, including inorganic and/or organic materials, which exhibit electrically insulative properties. It is believed that the electrically insulative properties of the insulating layer comes from materials with a large “band gap” or “electrical gap” (the energy difference in electron volts (eV) between the top of the valence band and the bottom of the conductive band) and a high conductance band minimum. When the insulative material has a large band gap and high conductance band minimum, very few electrons contain the energy to surmount the electrical gap and to move freely through the insulative material and thus are blocked at the interface of the insulating material and the second electrochromic material. It is believed that this blockage leads to an accumulation of electrons within the second electrochromic layer resulting in higher coloration or darkness efficiency due to the increase in the reduction of the n-type electrochromic materials caused by the excess electrons. It is believed that by using an insulating material having a large band gap and a large conductance band minimum value, the insulating layer blocks electrons from the cathode from passing through the insulating layer, thus trapping the electrons within the second electrochromic layer where they localize and aid in the reduction of the n-type electrochromic material causing a change in the material's optical properties from a first state (transparent) to a second state (dark). It is also believed that the use of the insulative materials with a large band gap block the holes from entering the insulative material, resulting in an accumulation of holes within the p-type electrochromic material, aiding in the oxidation of the p-type electrochromic material and causing a change in the material's optical properties from a first state (transparent) to a second state (dark). It is further believed that the utilization of materials with high dielectric constants result in higher charge storage within the p-type and n-type electrochromic material. It is believed that this increase in the stored charge leads to enhanced reduction of the n-type electrochromic material resulting in a darker second state and enhanced oxidation of the p-type electrochromic materials, also resulting in a darker second state. It is further believed that the higher charge storage results in a lower light transmittance. It is the cumulative effect of blocking both the holes and the electrons from passing into the insulative layer, and increasing the stored charge within the electrochromic layers' materials, that allows for the use of ultrathin layers of p-type electrochromic materials, n-type electrochromic materials, and insulative materials within the electrochromic elements and devices of the present disclosure.

In some embodiments, the insulating layer may be formed, in whole or in part, by oxide, nitride, and/or fluoride compounds, such as, for example, aluminum oxide (Al₂O₃), tantalum oxide (Ta₂O₃), yttrium oxide (Y₂O₃), hafnium oxide (HfO₂), calcium oxide (CaO), magnesium oxide (MgO) and/or zirconium oxide, Si₃N₄, AlN and lithium fluoride. In some embodiments, the insulating layer comprises aluminum oxide, yttrium oxide, hafnium oxide, zirconium oxide or tantalum oxide. In another embodiment, the insulating layer comprises a stoichiometric metal oxide compound, such as TiO₂, SiO₂, WO₃, Al₂O₃, Ta₂O₅, Y₂O₃, HfO₂, CaO, MgO or ZrO₂. In some embodiments, the insulating layer comprising non-stoichiometric metal oxide compounds are also contemplated. In some embodiments, the insulating layer can comprise aluminum oxide (Al₂O₃). In some embodiments, the insulating layer can comprise yttrium oxide (Y₂O₃). In some embodiments, the insulating layer can comprise hafnium oxide (HfO₂). In some embodiments, the insulating layer can comprise zirconium oxide (ZrO₂).

In some embodiments, wherein the insulating layer comprises a stoichiometric metal oxide compound, the metal oxide compound further comprises a doping material. In some embodiments, the metal oxide doping material can be silicon oxide (SiO₂). In some embodiments, the amount of silicon oxide doped in the metal oxide (e.g. Al₂O₃) can be between 2 wt % to about 40 wt %, about 2-4 wt %, about 4-6 wt %, about 6-8 wt %, about 8-10 wt %, about 10-15 wt % about 15-20 wt %, about 20-25 wt % to about 25-30 wt %, about 30-35 wt %, about 35-40 wt %, about 4-6 wt %, about 15-25 wt % about 20 wt %, about 5 wt %, or any wt % within the ranges cited of the total weight of metal oxide.

The insulating layer can have any suitable thickness, such as about 40 nm to about 300 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 70-90 nm, about 90-110 nm, about 130-150 nm, about 140-160 nm, about 40-80 nm, about 80-120 nm, about 120-160 nm, about 40-100 nm, about 100-160 nm, about 80 nm, about 100 nm, about 140 nm, about 150 nm, or any thickness in a range bounded by any of these values. In some embodiments, the insulating layer may have a thickness which is less than, equal to, and/or greater than the thickness of the first electrochromic layer or the second electrochromic layer. In some examples, the insulating layer comprises materials and/or structures that are effective in confining, on a selective basis, electrons and/or holes within the adjacent electrochromic layers. It is believed that confining the electrons and/or holes within their respective electrochromic layers can significantly increase the reduction and/or oxidation of the metal oxide electrochromic material leading to a lower percentage of transmittance (T %) at the second (darkened) state.

In some embodiments, the insulating layer may be effective for maintaining (in whole or in part) charges injected in the electrochromic materials of the adjacent electrochromic layers to be stored under a no bias condition; i.e., without continued application of an electric potential.

In some embodiments, the electrochromic element can further comprise a tunneling layer. In some embodiments, the tunneling layer has a nanostructured or rough surface morphology and is disposed between the second electrode and the second electrochromic layer. In some embodiments, the tunneling layer can be optically transmissive. In some examples, the tunneling layer provides a tunneling dielectric channel. In some embodiments, the tunneling layer comprises one or more electrically insulative materials, including inorganic and/or organic materials, which exhibit electrically insulative properties. Upon the application of a suitable electric potential, such as a voltage pulse, to the first and second electrode layers, band bending may occur in the tunneling layer in order to pass electrons to or from the second electrochromic layer, in order to alter at least one optical property (e.g., transmittance) of the second electrochromic material. In some embodiments, the tunneling layer can be formed in whole or in part by an oxide, nitride, and/or fluoride compound, such as, for example, aluminum oxide, tantalum oxide, yttrium oxide, calcium oxide, magnesium oxide and/or zirconium oxide, silicon nitride and aluminum nitride, and lithium fluoride. In some embodiments, the tunneling layer comprises aluminum oxide or tantalum oxide. In some embodiments, the tunneling layer comprises stoichiometric metal oxide layers such as Al₂O₃, Ta₂O₅, Y₂O₃, CaO, MgO or ZrO₂. The tunneling layer can have any suitable thickness in the range of about 0.1 nm-50 nm, about 0.1-0.2 nm, about 0.2-0.3 nm, about 0.3-0.4 nm, about 0.4-0.5 nm, about 0.5-0.6 nm, about 0.6-0.7 nm, about 0.7-0.8 nm, about 0.8-0.9 nm, about 0.9-1 nm, about 1-1.1 nm, about 1.1-1.2 nm, about 1.2-1.3 nm, about 1.3-1.4 nm, about 1.4-1.5, about 1.5-1.6 nm, about 1.6-1.7 nm, about 1.7-1.8 nm, about 1.8-1.9 nm, about 1.9-2 nm, about 2-3 nm, about 3-4 nm, about 4-5 nm, about 5-6 nm, about 6-7 nm, about 7-8 nm, about 8-9 nm, about 9-10 nm, about 10-15 nm, about 15-20 nm, about 20-25 nm, about 25-30 nm, about 30-35 nm, about 35-40 nm, about 40-45 nm, about 45-50 nm, about 1 nm, about 2 nm, about 3 nm, about 4 nm, about 10 nm, about 20 nm, about 30 nm, or any thickness in a range bound by any of these values.

In some embodiments, the nanostructured or rough surface morphology comprises the buffer layer. In some embodiments, the nanostructured or rough surface morphology comprises the first electrochromic layer. In some embodiments, the first electrochromic layer can have a dual function by operating as a buffer layer and a p-type electrochromic layer. This dual function of the first electrochromic layer can be achieved by using an annealing process with regard to the first electrochromic layer, in which the annealing temperature is at least 200° C. for at least 3 minutes.

As used herein, the term “plasmon” refers to collective oscillation of free electrons on a surface that is excited by an external electric field such as light. Because electrons are electrically charged, polarization occurs due to the density distribution of free electrons that is caused by oscillation of electrons. It is believed that the presence of nanostructured or rough surface morphology on the second electrode layer provides a site for the polarization. A phenomenon in which the polarization and an electromagnetic field are combined is referred to as “plasmon resonance.” In particular, a resonance phenomenon that occurs between light and plasma oscillations of free electrons generated on a metal microstructure or a metal particle surface can be referred to as localized surface plasmon resonance (LSPR). It is believed that the nanostructured or rough surface morphology of the second electrode layer in the present disclosure generates a local surface plasmon effect similar to that of a LSPR.

Specifically, the collective oscillation of free electrons on the nanostructured or rough surface morphology is excited by an external electric field such as light, density distribution of electrons and polarization accompanying the density distribution are generated by the oscillation. As a result, an electromagnetic field that is localized in the vicinity of the particle is generated.

As detailed above, second electrochromic layer comprises an electrochromic material. In some embodiments, the electrochromic material may include an electrochromic compound and a matrix material. In one particular, but non-limiting, form the electrochromic material includes a metal oxide such as WO₃. However, it should be appreciated that the electrochromic layers can include any electrochromic material or compound that changes optical transmittance and/or absorption when, for example, an insulating (or blocking, tunneling, or barrier) layer is present, it is in a charged-state that can be achieved by, for example, the charged injection from an electrode layer through a tunneling layer into the second electrochromic layer under an applied voltage pulse above a critical value where electron tunneling occurs.

Additionally, or alternatively, the electrochromic material can include charge sensitive materials that can be affected by a localized surface plasmon effect, as discussed above. In some forms, the electrochromic material may include both inorganic and/or organic materials. When an organic compound is included, it may be a low-molecular weight organic compound and/or a high-molecular weight organic compound. Each of these types of materials may be colored by the application of an electric potential as described herein. Non-limiting examples of high-molecular weight organic compounds of this type include those containing a pyridinium salt, and the compound can be, for example, a viologen-based high-molecular weight compound. In some embodiments, the electrochromic material can include a low-molecular weight organic compound. The electrochromic material comprises a compound that undergoes changes in optical properties, such as from a first state decolored form to a second state colored form, through an oxidation reaction (i.e., by giving up electrons) or a reduction reaction (i.e., by accepting electrons). In one or more forms, the electrochromic material includes one or more anodic electrochromic materials and/or one or more cathodic electrochromic materials.

In some embodiments, the electrochromic device can comprise a protection layer, such as protection layer 126 (See FIG. 2). In some embodiments, the protection layer can comprise a polymer or other material to protect the electrochromic device from moisture, oxidation, physical damage, etc. Suitable protective layers and or materials are described in the art.

It is contemplated that the electrochromic elements and devices herein could be used for a number of different purposes and applications. In one non-limiting form, for example, the electrochromic elements and devices herein could be used in a window member that includes a pair of transparent substrates with the electrochromic elements and devices described herein positioned between said transparent substrates. Owing to the presence of the electrochromic element or device of the present disclosure, the window member can adjust the quantity of light transmitted through the window member bearing the transparent substrates. In addition, the window member can include a frame which supports the electrochemical element or device of the current disclosure, and the window member can be used in an aircraft, an automobile, a house, or the like, just to provide a few possibilities. In some embodiments, the window member comprising the electrochemical element or device of the present disclosure can effect a difference in the transmission of light therethrough of at least 10%, at least 20%, at least 30%, at least 40%, at least 45%, at least 50%, at least 55%, at least 60%, at least 65%, at least 70%, at least 75%, at least 80%, at least 85%, at least 90%, at least 95%, or about 95%-100%, between the off and on state at a selected wavelength in the visible range of light.

In some embodiments, activation of or turning on the electrochromic materials of the first electrochromic layer and the second electrochromic layer involves injecting holes into the first electrochromic layer while electrons are injected into the second electrochromic layer as the second electrode is held at a ground potential and a positive voltage is applied to the first electrode. In some embodiments, the positive voltage (Vpp) may be from about 1 to about 5 volts, at least 12 volts when the positive read or operating voltage, Vdd, is about 5 volts, and from about 20 volts to about 25 volts, although other variations are contemplated. In order to deactivate or turn off the electrochromic material of the electrochromic layers, the second electrode can be held at a ground potential, and a negative voltage applied to the first electrode. Alternatively, both the first electrode can be held at a ground potential, and a positive voltage applied to the second electrode. In various embodiments, the negative voltage (−Vpp) may be, for example at least −1 volt, −2 volts, −4 volts, −5 volts, up to −12 volts (e.g., when the negative read or operating voltage (Vdd) is about −2 volts), or from about −20 volts to about −25 volts. A ground potential generally refers to a virtual ground potential or a voltage level of about 0 V. In some embodiments, programming is believed to be effected by conventional electron injection. Alternatively, holes may be stored on the electrochromic material by supplying a negative voltage (e.g., −Vpp) to the control gate/gate electrode. In a further alternative embodiment, a reference cell, “unprogrammed” transistor, or transistor storing a “0” binary logic state may be programmed to a complementary binary logic state using a bias opposite to that of the programmed cell(s), leading to a greater delta Vₜ between the programmed-unprogrammed cell pairs (e.g., the complementary binary logic states). The greater threshold voltage difference enhances the margin over which the devices are functional, increases data retention time, and/or allows read operations under less stringent (e.g., subthreshold swing) conditions.

While operation of the present disclosure has been described principally in connection with the electrochromic devices described herein, it is believed that the operating principles of the electrochromic devices and electrochromic elements described herein are the same. In FIG. 2, a voltage pulse is applied to the first electrode and the second electrode. Since the device is insulated under normal operation, the applied voltage pulse is only needed for switching states of the first electrochromic material of the first electrochromic layer and second electrochromic material of the second electrochromic layer. Further, as indicated above, electron and/or hole conduction may only occur upon application of a critical voltage pulse necessary to push electrons and/or holes into or out of the electrochromic material of the electrochromic layers. Moreover, given that the device is insulated under normal operation and the electrochromic material of the electrochromic layers is insulated from the electrodes and/or holes, the leakage of charges into or out of the electrochromic material is reduced, minimized, or eliminated.

The insulating effect of the blocking layer of the present disclosure may provide a wide band gap insulating effect, while the electrochromic layers, which could comprise a semiconductor, have a lower-level conduction band that can keep the electron[s] trapped therein as the “memory” effect (non-volatile), which reduces, minimizes and/or insures no power consumption under normal device operation unless a switching process is occurring. Similarly, this arrangement can reduce, minimize and/or eliminate the issue of leakage suffered in other forms of electrochromic devices. In addition, the insulative properties of the devices described herein allow the voltage applied from the power supply to the electrochromic material of electrochromic layers to be uniformly applied without a potential drop to the electrode, since the resistance of the device is much larger than the resistance of the electrode. Other forms of an electrochromic device may generally be highly conductive and, in applications for a larger area such as a window, the device has a much lower resistance and the electrode layer's resistance can be comparable to or less than the device's resistance. This may result in a drop across the electrode layer, which may cause non-uniformity in application of the power supply for applications of these devices in larger area applications. In contrast, as indicated above, it is believed the electrochromic elements and electrochromic devices of the present disclosure may be effective for minimizing, reducing or eliminating the occurrence of this issue.

In some embodiments of the present disclosure, the electrochromic material of the electrochromic layer can trap both electrons and holes. When a voltage pulse is supplied to the two electrodes above a critical value, the large band gap of the insulating layer may cause electron injection from the cathode electrode into the electrochromic material of second electrochromic layer and hole injection from the anode into the first electrochromic layer. The charges will be stored in the respective electrochromic layers due to the insulative effect provided by the insulating layer. The stored charges in the electrochromic material of electrochromic layers may cause a color change or a change in transmission/absorption. For example, it may cause a change from a first state that is clear to a second state that has high absorption (darkened).

Deactivation of or turning off the electrochromic material of first and the second electrochromic layers involves the inverse of the activation/turning on procedure. For example, if the electrochromic material of second electrochromic layer is activated/turned on by supplying a positive voltage to the first electrode, the deactivation/turning off operation involves supplying a negative voltage of about the same magnitude to the second electrode while the source electrode is held at a ground potential. Alternatively, if the electrochromic material of electrochromic layer is activated by supplying a negative voltage to the second electrode, the deactivation/turning off operation involves supplying a positive voltage of about the same magnitude to the control gate/gate electrode while the source electrode and drain electrode are held at a ground potential.

Some embodiments include a method for preparing an electrochromic device. In some embodiments, the method can comprise providing: a first electrode layer comprising a transparent conductive material; a first electrochromic layer comprising a p-type electrochromic material deposited upon and in physical and electrical communication with the first electrode layer; an insulating layer comprising an electrically insulating material deposited upon and in physical and electrical communication with the first electrochromic layer; a second electrochromic layer comprising a n-type electrochromic material deposited upon and in physical and electrical communication with the insulating layer; and a second electrode layer comprising transparent conductive material with a nanostructure surface morphology deposited upon and in physical and electrical communication with the second electrochromic layer. In some embodiments, the method can further comprise depositing a buffer layer having a nanostructure surface morphology between the first electrode layer and the first electrochromic layer. In some embodiments of the method, the p-type electrochromic material of the first electrochromic layer can comprise a nanostructure surface morphology upon an annealing process, wherein the annealing temperature is at least 200° C. In some embodiments of the method, the p-type electrochromic material with a nanostructure surface morphology operates as both the buffer layer and as the first electrochromic layer. In other embodiments of the method, the second electrode layer can have a thickness between about 10 nm to about 500 nm to allow the transfer of the nanostructure surface morphology from the buffer layer, imparting a complementary nanostructured surface morphology onto the transparent conductive material, wherein the transparent conductive material of the second electrode layer has a sufficient complementary nanostructure surface morphology to affect a local surface plasmon effect.

Some embodiments of the method further comprise electrically connecting the transparent conductive material of the first electrode layer and the transparent conductive material of the second electrode layer to a power source, wherein the first electrode layer and the second electrode layer are in electrical communication. In still other embodiments, the method further comprises a tunneling layer disposed between the second electrode layer and the second electrochromic layer.

Some embodiments include a method for preparing an electrochromic device, wherein the method can further comprise encapsulating the device with an optically transparent encapsulation material. The optically transparent encapsulating material can be oxygen limiting or preventing, not allowing or greatly reducing the exposure to atmospheric oxygen. The choice of encapsulating material is not limiting, and one skilled in the art of electrochromic devices could choose which encapsulating material to use.

### EMBODIMENTS

### Embodiment 1

An electrochromic element comprising:
A first electrode layer, wherein the first electrode layer comprises a transparent conductive material;
A first electrochromic layer in electrical communication with the first electrode layer, wherein the first electrochromic layer comprises a p-type electrochromic material;
An insulating layer in electrical communication with the first electrochromic layer, wherein the insulating layer comprises an electrically insulating material characterized by at least one of a band gap of at least 5 eV, a conductance band minimum of at least 2 eV relative to the materials Fermi level, or a dielectric constant of at least 5;
A second electrochromic layer in electrical communication with the insulating layer, wherein the second electrochromic layer comprises a n-type electrochromic material; and
A second electrode layer in electrical communication with the second electrochromic layer, wherein the second electrode layer comprises a transparent conductive material.

### Embodiment 2

The electrochromic element of embodiment 1, wherein the second electrode comprises a first and a second surface, and wherein the first surface comprises a nanostructured surface morphology.

### Embodiment 3

The electrochromic element of embodiment 1, wherein the element further comprises a buffer layer disposed between and in electrical communication with the first electrode layer and the first electrochromic layer.

### Embodiment 4

The electrochromic element of embodiment 3, wherein the buffer layer comprises an organic material, and, the nanostructured surface morphology can be replicated within the buffer layers organic material

### Embodiment 5

The electrochromic element of embodiment 4, wherein the organic material comprises a bisphenyl pyridine.

### Embodiment 6

The electrochromic element of embodiment 5, wherein the bisphenyl pyridine compound is:

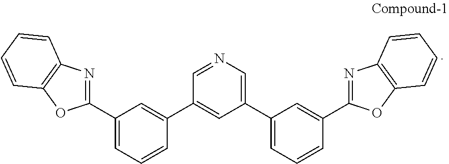 [SMILES: c1cc(-c2cncc(-c3cccc(-c4nc5ccccc5o4)c3)c2)cc(-c2nc3ccccc3o2)c1]

### Embodiment 7

The electrochromic element of embodiment 2, wherein the p-type electrochromic material of the first electrochromic layer comprises an inorganic material that crystallizes under an annealing process wherein the temperature is at least 200° C. resulting in the formation of a nanostructured surface morphology on the electrochromic layer.

### Embodiment 8

The electrochromic element of embodiment 2, wherein the p-type electrochromic material of embodiment 7 comprises the buffer layer.

### Embodiment 9

The electrochromic element of embodiment 8, wherein the insulating layer comprises an oxide, nitride or a fluoride compound.

### Embodiment 10

The electrochromic element of embodiment 9, wherein the insulating layer comprises a metal oxide compound.

### Embodiment 11

The electrochromic element of embodiment 10, wherein the metal oxide compound is aluminum oxide, hafnium oxide, zirconium oxide and/or yttrium oxide.

### Embodiment 12

The electrochromic element of embodiment 10, wherein the metal oxide compound further comprises a doping material.

### Embodiment 13

The electrochromic element of embodiment 12, wherein the doping material is silicon oxide.

### Embodiment 14

The electrochromic element of embodiment 1, wherein the buffer layer comprises an insulating material which provides band gap of at least 5 eV with a conductance band minimum of at least 2 eV relative to the materials Fermi level and a dielectric constant of at least 4.0.

### Embodiment 15

The electrochromic element of embodiment 1, wherein the p-type electrochromic material comprises an anodic material.

### Embodiment 16

The electrochromic element of embodiment 5, wherein the n-type electrochromic materials is a cathodic material.

### Embodiment 17

The electrochromic element of embodiment 1, wherein the transparent conductive material comprises a metal oxide.

### Embodiment 18

The electrochromic element of embodiment 1, wherein the element further comprises a power source, wherein the power source is in electrical communication with the first electrode layer and the second electrode layer.

### Embodiment 19

The electrochromic element of embodiment 1, wherein the element can further comprise a tunneling layer disposed between the second electrode layer and the second electrochromic layer.

### Embodiment 20

A system, comprising an electrochromic element of embodiment 1, including an electrochromic material, wherein at least one optical property of the electrochromic material may be changed from a first state to a second state upon application of an electric potential.

### Embodiment 21

The system of embodiment 20, further comprising a power source in electrical communication with the first and the second electrode layers to provide an electric potential to the system.

### Embodiment 22

A method for preparing an electrochromic device comprising:
providing a first electrode layer, wherein the first electrode comprises a transparent conductive material;
providing a first electrochromic layer, wherein the first electrochromic layer comprises a p-type electrochromic material, deposited upon and electrical communication with the first electrode layer;
providing an insulating layer, wherein the insulating layer comprise an electrically insulating material deposited upon and in electrical communication with the first electrochromic layer;
providing a second electrochromic layer, wherein the second electrochromic layer comprises a n-type electrochromic material, deposited upon and in electrical communication with the insulating layer; and
providing a second electrode layer, wherein the second electrode layer comprises a transparent conductive material with a nanostructured surface morphology deposited upon and in electrical communication with the second electrochromic layer.

### Embodiment 23

The method of embodiment 22, further comprising disposing a buffer layer, having a nanostructured surface morphology, between the first electrode layer and the first electrochromic layer.

### Embodiment 24

The method of embodiment 22, wherein the p-type electrochromic material of the first electrochromic layer forms a nanostructured surface morphology upon an annealing process, wherein the annealing temperature is at least 200° C.

### Embodiment 25

The first electrochromic layer of embodiment 23, wherein the p-type electrochromic material with a nanostructured surface morphology operates as the buffer layer and the first electrochromic layer.

### Embodiment 26

The method of embodiment 25, wherein the second electrode layer is of between about 10 nm to about 500 nm to allow the transfer of the nanostructured surface morphology from the buffer layer, imparting a complementary nanostructured surface morphology onto the transparent conductive material, wherein the transparent conductive material of the second electrode layer having a sufficient complementary nanostructured surface morphology to affect a localized surface plasmon effect.

### Embodiment 27

The method of embodiment 22, further comprising electrically connecting the transparent conductive material of the first electrode layer and the transparent conductive material of the second electrode layer to a power source, wherein the first electrode layer and the second electrode layer are in electrical communication.

### Embodiment 28

The method of embodiment 22, further comprising a tunneling layer disposed between the second electrode layer and the second electrochromic layer.

### Examples

It should be appreciated that the following Examples are for illustration purposes and are not intended to be construed as limiting the subject matter disclosed in this document to only the embodiments disclosed in these examples.

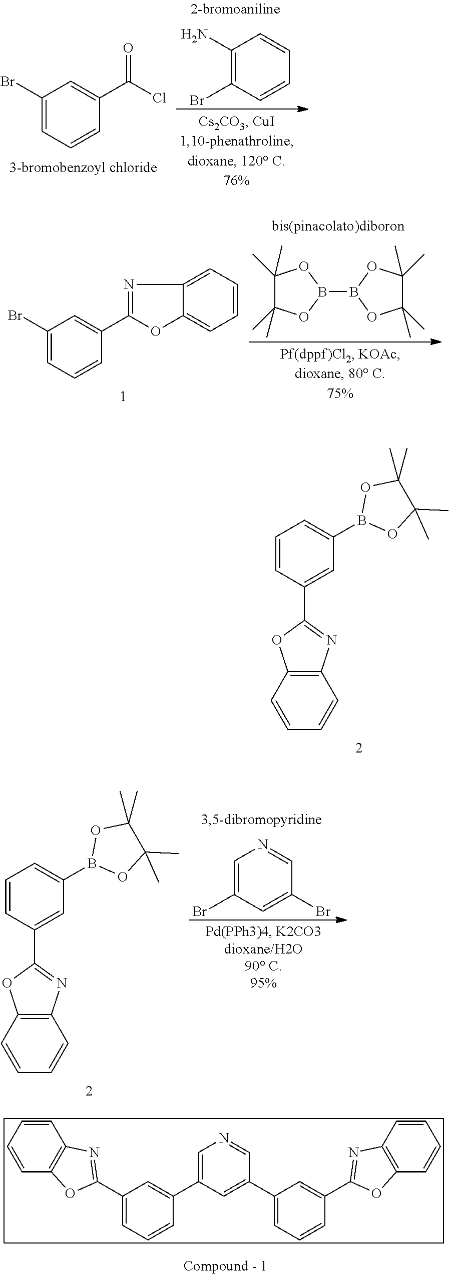

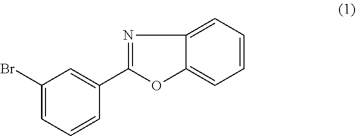 [SMILES: Brc1cccc(-c2nc3ccccc3o2)c1]

### 2-(3-bromophenyl)benzo[d]oxazole (1)

A mixture of 3-bromobenzoyl chloride (10.0 g, 45.6 mmol), 2-bromoaniline (7.91 g, 46 mmol), Cs₂CO₃ (30 g, 92 mmol), CuI (0.437 g, 2.3 mmol) and 1,10-phenanthroline (0.829 g, 4.6 mmol) in anhydrous 1,4-dioxane (110 mL) was heated at 120° C. for 8 h. After cooling to RT, the mixture was poured into ethyl acetate (300 mL), worked up with water (250 mL). The aqueous solution was extracted with dichloromethane (300 mL). The organic phase was collected, combined, and dried over Na₂SO₄. Purification by a short silica gel column (hexanes/ethyl acetate 3:1) gave a solid, which was washed with hexanes to give a light-yellow solid (9.54 g, 76% yield).

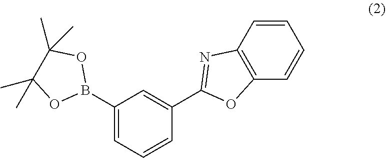 [SMILES: CC1(C)OB(c2cccc(-c3nc4ccccc4o3)c2)OC1(C)C]

### 2-(3-(4,4,5,5-tetramethyl-1,3,2-dioxaborolan-2-yl)phenyl)benzo[d]oxazole (2)

A mixture of 2-(3-bromophenyl)benzo[d]oxazole (2.4 g, 8.8 mmol), bis(pinacolato)diboron (2.29 g, 9.0 mmol), [1,1′-bis(diphenylphosphino)ferrocene]dichloropalladium (0.27 g, 0.37 mmol), and potassium acetate (2.0 g, 9.0 mmol) in anhydrous 1,4-dioxane (50 mL) was degassed, then heated at 80° C. overnight. After cooling to RT, the mixture was poured into ethyl acetate (100 mL). After filtration, the solution was absorbed on silica gel and purified by flash chromatography (hexanes/ethyl acetate 4:1) to give a white solid (2.1 g, 75% yield).

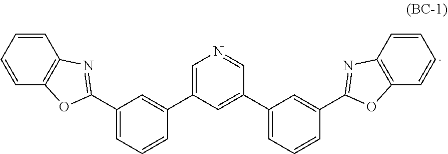 [SMILES: c1cc(-c2cncc(-c3cccc(-c4nc5ccccc5o4)c3)c2)cc(-c2nc3ccccc3o2)c1]

Compound-1 (BC-1):

A mixture of 3,5-dibromopyridine (0.38 g, 1.6 mmol), 2-(3-(4,4,5,5-tetramethyl-1,3,2-dioxaborolan-2-yl)phenyl)benzo[d]oxazole (1.04 g, 3.1 mol), Pd(PPh₃)₄ (0.20 g, 0.17 mmol) and potassium carbonate (0.96 g, 7.0 mmol) in dioxane/water (40 mL/8 mL) was degassed and heated at 90° C. overnight under argon. After cooling to RT, the precipitate was filtered and washed with methanol to give a white solid (0.73 g, 95% yield).

### Preparing Electrochromic Device EC-1

A pre-learned patterned ITO-glass substrate (first electrode) was loaded onto a hybrid sputtering/thermal vacuum deposition chamber (Angstrom Engineering, Inc.) set at 2×10⁻⁷ torr. First, a 1 nm layer of BC-1 was deposited onto the ITO-glass substrate at a deposition rate of 0.5 Å/s, creating a buffer layer. Then, a NiO (80 nm), p-type, electrochromic layer was deposited under vacuum of 2×10⁻′torr, from a Ni target under a working gas of Ar—O₂, where O₂ concentration was set at 30% with a deposition rate of 2 Å/s. Next, an Al₂O₃ (100 nm) insulation layer was deposited under vacuum of 2×10⁻⁷ torr, where the O₂ concentration was set at 15% with a deposition rate of 3 Å/s. Next, a WO₃ (200 nm) n-type, electrochromic layer was deposited under vacuum of 2×10⁻⁷ torr, from a W target under a working gas of Ar—O₂, where O₂ concentration was set at 35% with a deposition rate of 3 Å/s. Next, the ITO electrode (second electrode/cathode) was deposited at a deposition rate of 1.5 Å/s. Electrical connections were connected between a power source (Tektronix, Inc., Beaverton, Oreg., USA, Kethley 2400 source meter) and switched electrical connections with the electrodes to enable selective application of potential to the first electrode (on) or to the bottom or second electrode (off).

EC-2 device was prepared as described above except that the buffer layer was omitted from the device.

EC-3 was prepared as described above except the annealing process for the device was altered to 460° C. for 3 minutes to form dual function first electrochromic layer (buffer layer and electrochromic layer).

The devices of Examples, EC-2, EC-3, EC-4, EC-5, EC-6, EC-7, EC-8, EC-9, EC-10, EC-11, CE-1, CE-2, CE-3, and CE-4 were made in a manner similar to that described above with respect to the device of Example EC-1, except as indicated in Table 2 below.

TABLE 2
Electrochromic Devices

| | | | | First | | | Second | | |
|---|---|---|---|---|---|---|---|---|---|
| | | | | Electro- | | Electro- | Electro- | Nano- | |
| | Sub- | First | Buffer | chromic | Insulating | lyte | chromic | particle | Second |
| Example | strate | Electrode | layer | layer | layer | layer | layer | layer | Electrode |
| CE-1 | Glass | ITO | None | NiO | None | Ta205 | W03 | None | ITO |
| | | | | (150 nm) | | (100 nm) | (200 nm) | | (80 nm) |
| CE-2 | Glass | ITO | None | NiO | TiO₂ | None | WO₃ | None | ITO |
| | | | | (100 nm) | (100 nm) | | (200 nm) | | (80 nm) |
| CE-3 | Glass | ITO | None | NiO | ALN | None | WO₃ | None | ITO |
| | | | | (100 nm) | (100 nm) | | (200 nm) | | (80 nm) |
| CE-4 | Glass | ITO | None | NiO | SiO₂ | None | W03 | None | ITO |
| | | | | (100 nm) | (100 nm) | | (200 nm) | | (80 nm) |
| CE-5 | Glass | ITO | None | NiO | WO₃ | None | WO₃ | None | ITO |
| | | | | (100 nm) | (100 nm) | | (200 nm) | | (80 nm) |
| EC-1 | Glass | ITO | BC-1 | NiO | Al₂O₃ | None | WO₃ | None | ITO |
| | | | (1 nm) | (100 nm) | (80 nm) | | (200 nm) | | (80 nm) |
| EC-2 | Glass | ITO | None | NiO | Al₂O₃ | None | WO₃ | None | ITO |
| | | | | (100 nm) | (80 nm) | | (200 nm) | | (80 nm) |
| EC-3 | Glass | ITO | NiO | NiO | Al₂O₃ | None | WO₃ | None | ITO |
| | | | | (80 nm) | (100 nm) | | (200 nm) | | (80 nm) |
| EC-4 | Glass | ITO | None | NiO | AlN | None | WO₃ | None | ITO |
| | | | | (80 nm) | (100 nm) | | (200 nm) | | (80 nm) |
| EC-5 | Glass | ITO | None | NiO | Y₂O₃ | None | WO₃ | None | ITO |
| | | | | (80 nm) | (100 nm) | | (200 nm) | | (80 nm) |
| EC-6 | Glass | ITO | None | NiO | HfO₂ | None | WO₃ | None | ITO |
| | | | | (80 nm) | (100 nm) | | (200 nm) | | (80 nm) |
| EC-7 | Glass | ITO | None | NiO | Si (5%)- | None | WO₃ | None | ITO |
| | | | | (100 nm) | Al₂O₃ | | (200 nm) | | (80 nm) |
| | | | | | (100 nm) | | | | |
| EC-8 | Glass | ITO | None | NiO | Si (5%)- | None | WO₃ | None | ITO |
| | | | | (125 nm) | Al₂O₃ | | (200 nm) | | (80 nm) |
| | | | | | (140 nm) | | | | |
| EC-9 | Glass | ITO | None | NiO | Si (20%)- | None | WO₃ | None | ITO |
| | | | | (125 nm) | Al₂O₃ | | (200 nm) | | (80 nm) |
| | | | | | (140 nm) | | | | |
| EC-10 | Glass | ITO | None | NiO | Si (20%)- | None | WO₃ | None | ITO |
| | | | | (125 nm) | Al₂O₃ | | (200 nm) | | (80 nm) |
| | | | | | (150 nm) | | | | |
| EC-11 | Glass | ITO | None | NiO | ZrO2 | None | WO₃ | None | ITO |
| | | | | (100 nm) | (100 nm) | | (400 nm) | | (80 nm) |

### Transmissive (T %)

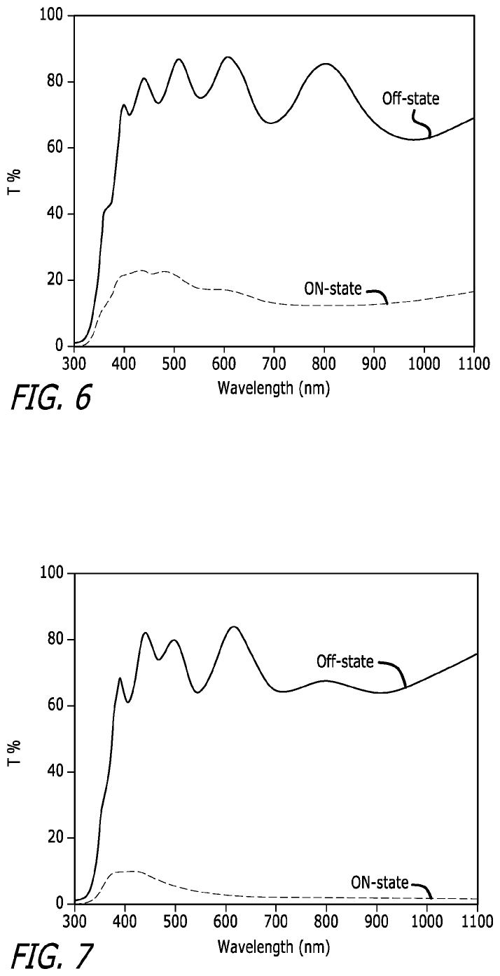

In addition, total light transmittance data of the examples were measured by using the measurement system like that described in U.S. Pat. No. 8,169,136 (shown there and described in FIG. 16 (MCPD 7000, Otsuka Electronics, Inc., Xe lamp, monochromator, and integrating sphere equipped). FIGS. 6-11 show the total light transmittance spectrum of the ON state and OFF state of embodiments tested, e.g., Samples CE-1, EC-2, EC-1, EC-3, EC-4 and EC-11.

The Example EC-3 device as described herein was positioned onto a Filmetrics F10-RT-YV reflectometer (Filmetrics, San Diego, Calif., USA), and the total transmission therethrough (T %) for ON state and OFF state was determined over varying wavelengths of light. The results are shown in FIG. 9. At about 630 nm, total transmission (T %) was about 1.1% at 630 nm in the On-state, and about 90% at 630 nm in the Off-state.

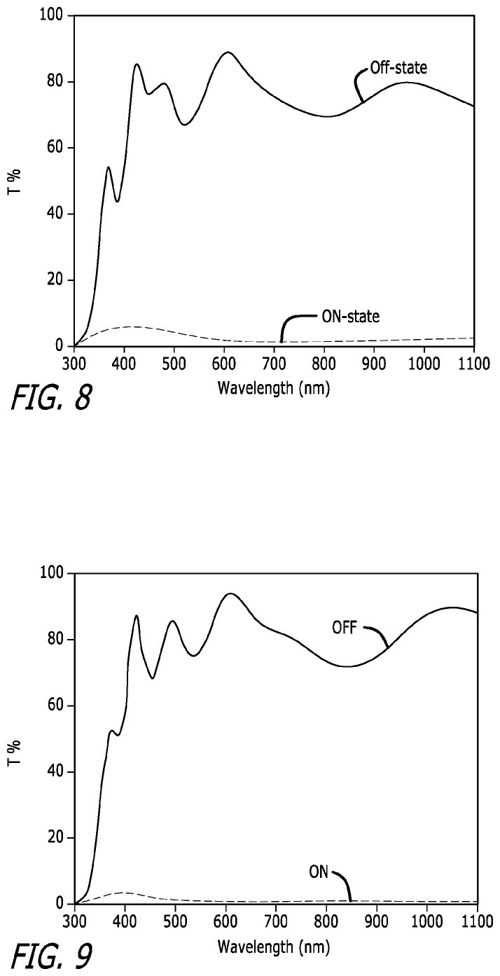

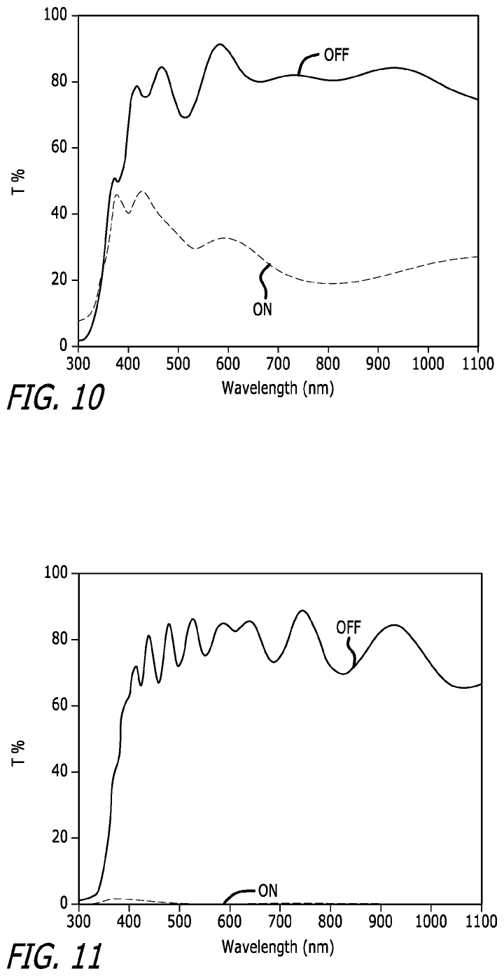

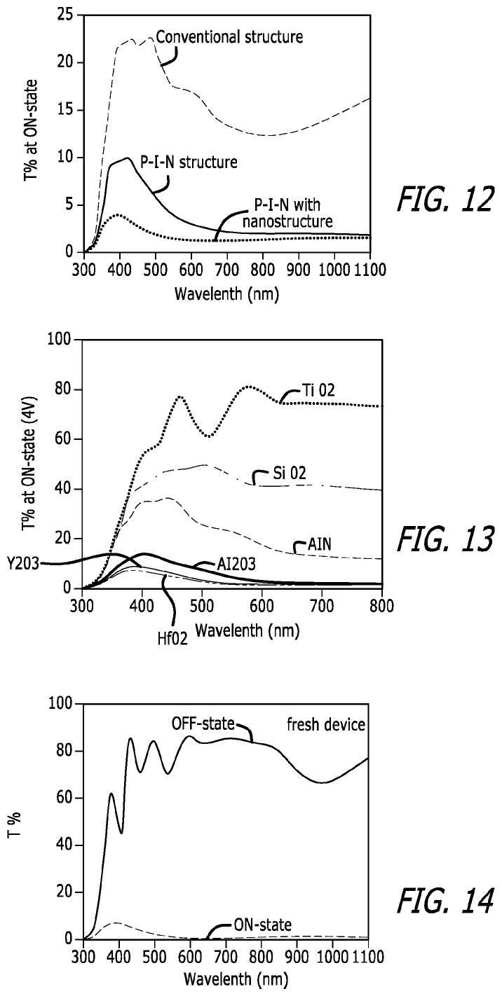

The T % ON state and OFF state for devices with CE-1 (conventional electrochromic device with electrolyte layer), EC-1 (1 nm buffer layer), EC-2, (no buffer layer), EC-3 (p-type electrochromic layer providing the nanostructured surface morphology) and EC-4 (AlN used as the insulating layer with p-type electrochromic layer providing the nanostructured surface morphology), EC-11 (zirconium oxide (ZrO₂) insulating layer with no buffer layer); are shown in FIGS. 6, 7, 8, 9, 10 and 11 respectively. At 630 nm, they showed a difference between on and off state T %, at 630 nm of 54.2% (FIG. 6, CE-1); of 72.4% (FIG. 7, EC-2); of 84.4% (FIG. 8, EC-1); of 88.9% (FIG. 9, EC-3); of 66.5% (FIG. 10, EC-4); of 87.2% (FIG. 11, EC-11). As shown, the embodiments of an p-type EC material, insulating layer and n-type EC material alone (FIG. 12, graph depicting the On-state T % of Conventional device (CE-1), PIN structured device (EC-1) and PIN structured device with an optional buffer layer (EC-3) and in combination with a buffer layer show improvement over the comparative embodiment with neither layer. Furthermore, the embodiments show that it may be important for the insulating layer to contain a material that has both a large band gap and a conductance band minimum of at least 2 eV for there to be significant improvement in T % over the comparative embodiment. FIG. 13 illustrates the ON state T % for different insulation layers. As evidenced by the embodiments, the combination of a large band gap with a conductance band minimum of at least 2 eV with a nanostructured surface morphology shows significant improvement in the T % compared with the comparative embodiment, with the nanostructured surface from the p-type EC material showing the best results.

### % Transmission

Additional results are also shown in Table 3a (EC-1, EC-2, CE-3) and Table 3B (CE-2, CE-3, CE-4, CE-5, EC-4, EC-5, EC-6) below

(Δ(eV)=band gap of the insulating material, E_{c} to E_{f} (eV)=the conductance band of the insulating material and £=the dielectric constant of the insulating material).

TABLE 3A

| | | | Darkness efficiency |
|---|---|---|---|
| | T % | T % | Off/On ratio per unit |
| | OFF-state | ON-state | EC layer thickness |
| # | @ 630 nm | @ 630 nm | (nm) |
| CE-1 | 82.9 | 15.8 | 0.014/nm |
| EC-1 | 86 | 1.6 | 0.18/nm |
| EC-2 | 81.4 | 2.6 | 0.088/nm |
| EC-3 | 90 | 1.1 | 0.29/nm |
| EC-4 | 82 | 15.5 | 0.019/nm |

TABLE 3B

| | | E_{c}to | Electron barrier | | |
|---|---|---|---|---|---|
| # | Δ(eV) | E_{f}(eV) | (WO₃/blocking) | T %-dark | ε |
| CE-2 | 3.2 | 0.7 | 0.5 | 75% | 80 |
| CE-3 | 6.2 | 1.8 | 1.6 | 15% | 4.8 |
| EC-3 | 8.7 | 4.35 | 4.15 | 2.8% | 9 |
| EC-5 | 5.6 | 2.8 | 2.6 | 1.65% | 15 |
| EC-6 | 25.8 | 2.5 | 2.3 | 1.38% | 25 |
| EC-11 | 5.8 | 2.36 | 2.16 | <0.1% | 25 |
| CE-4 | 9.0 | 4.5 | 4.3 | 41% | 3.9 |
| CE-5 | 3.2 | 0.2 | 0 | NA | NA |

Based on these results, it can be seen that the T % for the devices drastically change with the addition of the p-type EC material nanostructure surface morphology template. It can also be seen that, for the device with the buffer layer and with the addition of the p-type EC material nanostructure surface morphology template, there is a greater difference between the T % from the initial state to the on-state then with the buffer layer alone.

### Accelerated Stability Test

Accelerated stability tests the devices durability over long periods. The accelerated stability tests speed up the degradation of electrochromic devices materials by increasing the temperature to 70° C. Accelerated stability tests were performed on bare device, (devices that are not encapsulated, sealed edges). Fresh bare devices baseline transmission percent (T %) readings were taken, as described above. The fresh devices were then placed in a VWR Forced Air Oven (WVR International Co., Radnor Pa., USA), set at 70° C., normal atmosphere, for 127-hours. After exposure to 70° C. at normal atmosphere for 127-hours the devices T % was read, at 630 nm, and recorded, see Table 4 below. The difference between the base line T % read and the 127-hour 70° C. exposed read were compared. If the device experience significant insulating layer failure, the ΔT % (the difference between the off state and the one state T %) will be significantly different from the ΔT % of the 70° C. 127-hour device.

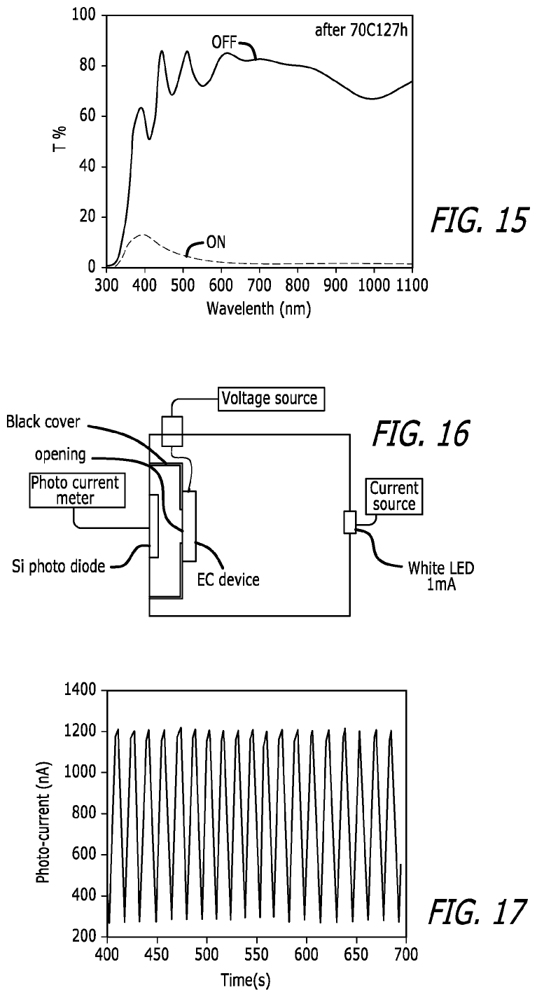

FIGS. 14 and 15 represents the data for device EC-9, where the baseline (fresh) device's ΔT % was 83 and the ΔT % of the baked age accelerated device was 82.1.

TABLE 4

| | Fresh T % @ 630 nm | | | 70° C. - 127 Hrs T % @ 630 m | | |
|---|---|---|---|---|---|---|
| # | OFF | ON | Δ % T | OFF | ON | Δ % T |
| EC-2 | 90 | 3 | 87 | 85 | 75 | 10 |
| EC-7 | 85.7 | 1.2 | 84.5 | 80.8 | 5.9 | 79.9 |
| EC-8 | 79.6 | 1.0 | 78.6 | 68.9 | 1.9 | 67 |
| EC-9 | 84.1 | 1.1 | 83 | 84 | 1.9 | 82.1 |
| EC-10 | 87.6 | 1.1 | 86.5 | 85.9 | 2.3 | 83.6 |

### Cycle Durability Test

Cycle durability tests the number of write/erase or color/de-colorization of an electrochromic device. Cycle durability tests were performed by applying a forward bias (switching on) of +4 V and then applying a reverse bias (switching off) of −4 V using the apparatus illustrated in FIG. 16. First a black box was prepared with a current source (Keithley Model 2000, Tektronix Inc., Beaverton, Oreg. USA), attached to a 1 mA white LED light, at one side of the box and a stage (black cover with an opening in the center of the stage for light to project through) for mounting the electrochromic element at the opposing side of the current source. A voltage source (Kethley 2400 source meter, Tektronix Inc.) was attached to the electrochromic element. Located directly behind the opening the stage and mounted to the inside of the black box is a silicon photo diode with a photo current meter (Keithley Model 400, Tektronix Inc.) attached for measuring the transmittance of light, from a white LED flowing through the electrochromic element in a dark box.

FIG. 17 represents the data for the cycle durability of device EC-1 where the durability is represented by the photo-current (nA) plotted over time (s).

### Coloration Efficiency Test

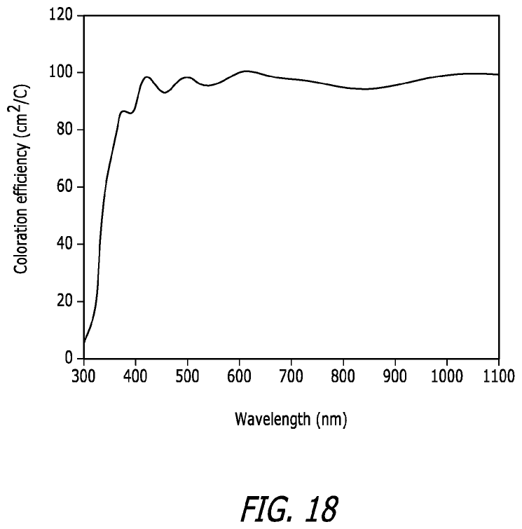

Total light transmittance data for Example EC-3 was measured by using a measurement system like that described in U.S. Pat. No. 8,169,136 (shown there and described in FIG. 16 (MCPD 7000, Otsuka Electronics, Inc., Xe lamp, monochromator, and integrating sphere equipped). About +4 volts from a power source was applied to Example EC-3 device to activate it to an On-state and then about −4 volts were applied to the example EC-3 device to deactivate it to an Off-state. Transmittance percentage (T %) for both On-state and Off-state of device EC-9 were recorded. FIG. 18 represents the data for device EC-3 where the switching corresponds to the T % at a 630 nm wavelength, Off-state T %=79% and On-state T %=6%. Coloration efficiency (CE) was calculated using formula:

$$CE = S ( {cm}^{2} ) \frac{ln \frac{T ( off )}{T ( on )}}{Q ( C )}$$

where S is the device activation area (here S=2.4 cm²), T(off) is the off-state T %, T(on) is the on-state T %, Q is the total injected electrical charge and C is the unit of charge, Coulomb. Results for example EC-3 are graphically illustrated in FIG. 18.

For the processes and/or methods disclosed, the functions performed in the processes and methods may be implemented in differing order, as may be indicated by context. Furthermore, the outlined steps and operations are only provided as examples, and some of the steps and operations may be optional, combined into fewer steps and operations, or expanded into additional steps and operations.

This disclosure may sometimes illustrate different components contained within, or connected with, different other components. Such depicted architectures are merely examples, and many other architectures can be implemented which achieve the same or similar functionality.

The terms used in this disclosure, and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.). In addition, if a specific number of elements is introduced, this may be interpreted to mean at least the recited number, as may be indicated by context (e.g., the bare recitation of “two recitations,” without other modifiers, means at least two recitations, or two or more recitations). As used in this disclosure, any disjunctive word and/or phrase presenting two or more alternative terms should be understood to contemplate the possibilities of including one of the terms, either of the terms, or both terms. For example, the phrase “A or B” will be understood to include the possibilities of “A” or “B” or “A and B.”

The terms and words used are not limited to the bibliographical meanings but are merely used to enable a clear and consistent understanding of the disclosure. It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes, which come within the meaning and range of equivalency of the claims, are to be embraced within their scope.

1. An electrochromic element comprising:
a first electrode layer, wherein the first electrode layer comprises a transparent conductive material;
a first electrochromic layer in electrical communication with the first electrode layer, wherein the first electrochromic layer comprises a p-type electrochromic material;
an insulating layer in electrical communication with the first electrochromic layer;
a second electrochromic layer in electrical communication with the insulating layer, wherein the second electrochromic layer comprises an n-type electrochromic material; and
a second electrode layer in electrical communication with the second electrochromic layer, wherein the second electrode layer comprises a transparent conductive material.

2. The electrochromic element of claim 1, wherein the insulating layer comprises an electrically insulating material characterized by at least one band gap of at least 5 eV, a conductance band minimum of at least 2 eV relative to the material's Fermi level, and a dielectric constant of at least 5.

3. The electrochromic element of claim 1, wherein the element further comprises a buffer layer disposed between, and in electrical communication with, the first electrode layer and the first electrochromic layer.

4. The electrochromic element of claim 3, wherein the buffer layer comprises an organic material having a nanostructured surface morphology.

5. The electrochromic element of claim 4, wherein the organic material comprises a bisphenyl pyridine.

6. The electrochromic element of claim 5, wherein the bisphenyl pyridine compound is:

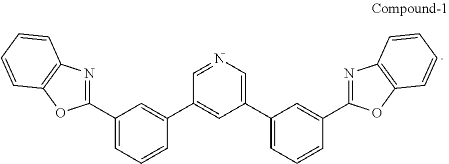 [SMILES: c1cc(-c2cncc(-c3cccc(-c4nc5ccccc5o4)c3)c2)cc(-c2nc3ccccc3o2)c1]

7. The electrochromic element of claim 1, wherein the p-type electrochromic material of the first electrochromic layer comprises an inorganic material that crystallizes under an annealing process, wherein the annealing process temperature is at least 200° C., and wherein the annealing process results in the formation of a nanostructured surface morphology on the electrochromic layer.

8. The electrochromic element of claim 1, wherein the p-type electrochromic material of the first electrochromic layer comprises nickel oxide (NiO).

9. The electrochromic element of claim 1, wherein the n-type electrochromic material of the second electrochromic layer comprises tungsten oxide (WO₃).

10. The electrochromic element of claim 1, wherein the insulating layer comprises an oxide, nitride, or a fluoride compound.

11. The electrochromic element of claim 10, wherein the oxide compound comprises aluminum oxide, hafnium oxide, zirconium oxide, or yttrium oxide.

12. The electrochromic element of claim 10, wherein the insulating layer further comprises a doping material.

13. The electrochromic element of claim 12, wherein the doping material is silicon oxide.

14. The electrochromic element of claim 1, wherein the transparent conductive material of the first electrode comprises indium tin oxide.

15. The electrochromic element of claim 1, wherein the transparent conductive material of the second electrode comprises indium tin oxide.

16. The electrochromic element of claim 1, wherein the element further comprises a tunneling layer disposed between the second electrode layer and the second electrochromic layer.

17. The electrochromic element of claim 1, wherein the second electrode comprises a nanostructured surface morphology complementary to the buffer layer, the first electrochromic layer, or the tunneling layer.

18. An electrochromic device comprising:
an electrochemical element of claim 1, wherein the element further comprises a power source, wherein the power source is in electrical communication with the first electrode layer and the second electrode layer to provide an electric potential to the device.

19. The electrochromic device of claim 18, wherein at least one optical property of the electrochromic device may be changed from a first state to a second state upon application of an electric potential; and wherein the electrochromic device is structured so that the second state is maintained without continued application of the electric potential.

20. The electrochromic device of claim 18, wherein the buffer layer or first electrochromic layer is deposited on the first electrode in a manner that results in a nanostructured template morphology; and
wherein the deposition of subsequent layers upon the buffer layer or first electrochromic layer are of suitable thickness that the nanostructured template morphology is maintained in the second electrode to affect a localized surface plasmon resonance.
